(19) United States
(12) Patent Application Publication
(10) Pub. No.: US 2020/0259880 A1
(43) Pub. Date: Aug. 13, 2020

(54) DATA PROCESSING METHOD AND APPARATUS

(71) Applicant: SZ DJI TECHNOLOGY CO., LTD., Shenzhen (CN)

(72) Inventors: Chuantang XIONG, Shenzhen (CN); Liming FAN, Shenzhen (CN); Zhiqiang WU, Shenzhen (CN)

(21) Appl. No.: 16/861,947

(22) Filed: Apr. 29, 2020

Related U.S. Application Data
(63) Continuation of application No. PCT/CN2018/102988, filed on Aug. 29, 2018.

(30) Foreign Application Priority Data
Nov. 7, 2017 (CN) PCT/CN2017/109798

(51) Int. Cl. H04L 29/06; H04N 7/18; H04L 29/08; H04L 12/861

(52) U.S. Cl. CPC H04L 65/607; H04N 7/185; H04L 63/0876; H04L 49/9084; H04L 67/26

(57) ABSTRACT

A data processing method includes receiving a first data stream from a data source, where the first data stream is obtained by encoding original data according to a first encoding parameter; decoding the first data stream to obtain the original data; determining, at a data-processing apparatus remote from the data source, a second encoding parameter according to one or more factors that are associated with the data-processing apparatus; and encoding the original data to obtain a second data stream according to the second encoding parameter.

### CROSS-REFERENCE TO RELATED APPLICATIONS

This application is a continuation of International Application No. PCT/CN2018/102988, filed on Aug. 29, 2018, which claims priority to International Application No. PCT/CN2017/109798, filed on Nov. 7, 2017, the entire contents of both of which are incorporated herein by reference.

### TECHNICAL FIELD

The present disclosure generally relates to the field of data processing and, more particularly, to a data processing method, a communication method, and a data-processing apparatus.

### BACKGROUND

In conventional technologies, an unmanned aerial vehicle (UAV) can perform tasks such as inspection and detection, and can send the captured data such as image data to a ground-based terminal, e.g., a ground-based control terminal. The ground-based control terminal can receive the captured data from the UAV and send the data to a server. A remote terminal can establish a communication connection with the server and receive the data in real time, such as watching a video reproduced from the image data in real time.

However, a network condition between the ground-based terminal and the server varies from time to time. When the network condition is poor, the ground-based terminal cannot smoothly send the data obtained from the UAV to the server. As a result, delays, lags, or the like may happen on the data such as the image data displayed on the remote terminal, and a user experience may be poor.

### SUMMARY

In one aspect, the present disclosure provides a data processing method. The data processing method includes receiving a first data stream from a data source, where the first data stream is obtained by encoding original data according to a first encoding parameter; decoding the first data stream to obtain the original data; determining, at a data-processing apparatus remote from the data source, a second encoding parameter according to one or more factors that are associated with the data-processing apparatus; and encoding the original data to obtain a second data stream according to the second encoding parameter.

Another aspect of the present disclosure provides another data processing method including obtaining source data stream from a data source, decoding the source data stream to obtain decoded data, and encoding the decoded data and auxiliary information to obtain combined data.

Another aspect of the present disclosure provides a communication method including obtaining an address segment from a receiving device, obtaining a communication address according to the address segment and locally stored authentication information; and communicating with the receiving device according to the communication address.

Another aspect of the present disclosure provides a data-processing apparatus including a processor and a memory storing instructions. The instructions, when executed by the processor, cause the processor to receive a first data stream from a data source, the first data stream being obtained by encoding original data according to a first encoding parameter; decode the first data stream to obtain the original data; determine, at a data-processing apparatus remote from the data source, a second encoding parameter according to one or more factors that are associated with the data-processing apparatus; and encode the original data to obtain a second data stream according to the second encoding parameter.

Another aspect of the present disclosure provides another data-processing apparatus including a processor and a memory storing instructions. The instructions, when executed by the processor, cause the processor to obtain source data stream from a data source; decode the source data stream to obtain decoded data; and encode the decoded data and auxiliary information to obtain combined data.

Another aspect of the present disclosure provides another data-processing apparatus including a processor and a memory storing instructions. The instructions, when executed by the processor, cause the processor to obtain an address segment from a receiving device; obtain a communication address according to the address segment and locally stored authentication information; and communicate with the receiving device according to the communication address.

### BRIEF DESCRIPTION OF THE FIGURES

The following drawings are merely examples for illustrative purposes according to various disclosed embodiments and are not intended to limit the scope of the present disclosure.

FIG. 1 illustrates a schematic diagram showing an application scenario of data transmission according to various disclosed embodiments of the present disclosure.

FIG. 2 illustrates a flow chart of an exemplary data processing method according to various disclosed embodiments of the present disclosure.

FIG. 3 illustrates a flowchart of another exemplary data processing method according to various disclosed embodiments of the present disclosure.

FIG. 4 illustrates a schematic diagram illustrating a determination of an encoding parameter according to various disclosed embodiments of the present disclosure.

FIGS. 5A and 5B illustrates schematic diagrams for stored data amount of data stream stored in a buffer and to be sent, first data amount threshold, and lower limit data amount threshold according to various disclosed embodiments of the present disclosure.

FIG. 6 illustrates a schematic view of determining an encoding parameter according to stored data amount of data stream stored in a buffer and to be sent according to various disclosed embodiments of the present disclosure.

FIGS. 7A and 7B illustrates schematic diagrams for stored data amount of data stream stored in a buffer and to be sent, second data amount threshold, and upper limit data amount threshold according to various disclosed embodiments of the present disclosure.

FIG. 8 illustrates another schematic view of determining an encoding parameter according to stored data amount of data stream stored in a buffer and to be sent according to various disclosed embodiments of the present disclosure.

FIG. 9 illustrates a flow chart of another exemplary data processing method according to various disclosed embodiments of the present disclosure.

FIG. 10 illustrates a flow chart of another exemplary data processing method according to various disclosed embodiments of the present disclosure.

FIG. 11 illustrates a schematic view of example devices involved in the transmission of a data stream stored in a buffer according to various disclosed embodiments of the present disclosure.

FIG. 12 illustrates a flow chart of an example of a data pushing process according to various disclosed embodiments of the present disclosure.

FIG. 13 illustrates a flowchart of an exemplary communication method according to various disclosed embodiments of the present disclosure.

FIG. 14 illustrates a flow chart of another exemplary data processing method according to various disclosed embodiments of the present disclosure.

FIG. 15 illustrates a block diagram of an exemplary hardware configuration of an exemplary data-processing apparatus according to various disclosed embodiments of the present disclosure.

### DETAILED DESCRIPTION

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Exemplary embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Further, in the present disclosure, the disclosed embodiments and the features of the disclosed embodiments may be combined under conditions without conflicts.

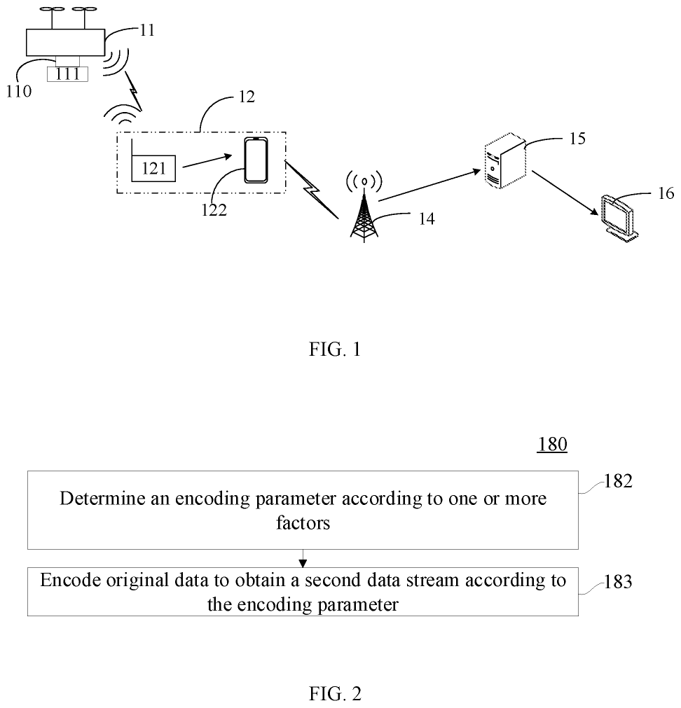

FIG. 1 illustrates a schematic diagram showing an application scenario of the data transmission, such as image data transmission, according to various disclosed embodiments of the present disclosure. As shown in FIG. 1, an unmanned aerial vehicle (UAV) 11 is connected to a gimbal 110. A photographing device 111 for photographing a still picture or moving pictures (e.g., a video) is carried by the UAV 11 through the gimbal 110. Hereinafter, still pictures or moving pictures are all referred to as images and data corresponding to an image (a still picture or a video) is referred to as “image data.” The UAV 11 transmits data, e.g., the image data generated by the photographing device 111, to a data-processing apparatus, e.g., a control terminal 12, on the ground. That is, the UAV 11 can include a data source or act as a data source. The data-processing apparatus can include, for example, a control terminal that can be operated by a user and/or an apparatus that may not need an input of a user. In various embodiments of the present disclosure described below, the term “control terminal” is used as an example of the data-processing apparatus or as an example device that acts as the data-processing apparatus, which is merely for illustrative purposes. In these embodiments, where appropriate, the control terminal can be replaced with another data-processing apparatus such as the apparatus that may not need an input of a user. The control terminal may include, for example, one or more of a remote control device, a smart phone, a tablet computer, a laptop computer, and a wearable device such as a wrist watch or a wristband.

In various embodiments of the present disclosure, a UAV, such as the UAV 11, is used as an example of the data source for providing data to the data-processing apparatus, which is merely for illustrative purposes. In some embodiments, instead of the UAV, another device, such as a ground-based unmanned vehicle or a handheld gimbal-based apparatus, can serve as the data source for providing data to the data-processing apparatus.

A user can control the UAV 11 through the control terminal 12, and the control terminal 12 can receive data, e.g., image data, captured by the photographing device 111 and transmitted from the UAV 11. That is, the control terminal 12 can be an example of the data-processing apparatus or can be an example device that acts as the data-processing apparatus. The control terminal 12 can transmit the data to a receiving device 15, e.g., a server. In some other embodiments, the receiving device may include another suitable receiving device. In some embodiments, as shown in FIG. 1, the control terminal 12 includes, for example, a remote control device 121 and a terminal device 122. The user may control the UAV 11 to fly by using the remote control device 121 and/or the terminal device 122. In addition, the remote control device 121 may also communicate with the terminal device 122. The communication may include wired communication and/or wireless communication. Through the communication between the remote control device 121 and the terminal device 122, the remote control device 121 may transmit data that is received from the UAV 11, e.g., image data, to the terminal device 122. The terminal device 122 may include a mobile phone, a tablet computer, a notebook computer or the like. In some embodiments, for example, the terminal device 122 may include a mobile phone. The user can view, on the terminal device 122, the image captured by the photographing device 111 carried by the UAV 11. In order to allow a remote user, i.e., a user not using or close by the terminal device 122, to view the data through a remote terminal 16, the control terminal 12 may transmit the data received or obtained from the UAV 11 to the receiving device 15. In some embodiments, the terminal device 122 may transmit the data to the receiving device 15 through a base station 14. The receiving device 15 can include, for example, a server. The server can include, for example, a streaming media server or a cloud server. The receiving device 15, e.g., a server, may communicate with the remote terminal 16, and the remote terminal 16 may obtain the data from the receiving device 15.

In various application scenarios, a network condition between the control terminal 12 and the receiving device 15 may vary. For example, a network condition between the terminal device 122 and the receiving device 15 may vary. In some cases, the network condition between the control terminal 12 and the receiving device 15 may be relatively poor, a channel bandwidth between the control terminal 12 and the receiving device 15 may be relatively narrow, and the control terminal 12 may not be able to smoothly transmit the data received or obtained from the UAV 11 to the receiving device 15.

In some embodiments, for example, the UAV 11 may obtain original data through the photographing device 111, may encode the original data to obtain, i.e., generate, source data according to an original-data encoding parameter, also referred to as a “first encoding parameter.” Thus, the source data may include the original data or data associated with the original data. In some embodiments, the source data may be, for example, in a form of data stream. Correspondingly, the source data may include a source data stream, also referred to as a “first data stream.”

In some embodiments, the UAV 11 may further transmit the source data to the control terminal 12.

In some embodiments, the control terminal 12 may decode the received source data, e.g., the source data stream, to obtain (recover) the original data, and may encode the decoded data, i.e., the recovered original data, to obtain another data stream, also referred to as a “second data stream.” The manner of the control terminal 12 to encode the recovered original data may be different from the manner of the UAV 11 to encode the original data. For example, the control terminal 12 can encode the recovered original data according to another encoding parameter, also referred to as a “second encoding parameter.” For simplicity, hereinafter, the recovered original data is also referred to as original data. The control terminal 12 may further store the second data stream in a buffer, waiting to be read and sent to a receiving device by a communication interface. Before the second data stream is obtained, a third data stream may exist in the buffer, waiting to be read and sent to the receiving device by the communication interface, where the third data stream may include a data stream previously obtained by decoding source data from the UAV and encoding the decoded data. A data stream may include, for example, an image data stream. In some embodiments, the first encoding parameter can be different from the second encoding parameter. The first encoding parameter may be used for encoding the original data to obtain the first data stream that is transmitted from the UAV 11 to the control terminal 12. Thus, the first encoding parameter may be chosen for matching with data transmission from the UAV 11 to the control terminal 12. The second encoding parameter may be used for encoding the original data to obtain a data stream that is transmitted from the control terminal 12 to a receiving device, such as the above-described second data stream. Thus, the second encoding parameter may be chosen for matching with data transmission from the control terminal 12 to the receiving device.

When the network condition is relatively poor, a relatively large number of data streams may be stored in a local buffer of the control terminal 12. Accordingly, the remote terminal 16 may not smoothly obtain data from the receiving device 15. Delays, lags, or the like may happen in the remote terminal 16, and a viewing quality may be reduced.

The present disclosure provides a method and an apparatus for data processing and transmission, and a UAV. Example data processing and transmission methods are described below with reference to various disclosed embodiments.

The present disclosure provides a data processing method. The method may be performed by, for example, a data-processing apparatus such as a control terminal. For example, a possessor of the control terminal may be configured to perform the method consistent with the disclosure. FIG. 2 illustrates a flow chart of an exemplary data processing method according to various disclosed embodiments of the present disclosure. With reference to FIG. 2, the data processing method is described below.

At 182, an encoding parameter is determined according to one or more factors.

The one or more factors may include factors associated with the data-processing apparatus. In some embodiments, the one or more factors may include a parameter that reflects a network status between the data-processing apparatus and a receiving device.

In some embodiments, the one or more factors may include at least one of a stored data amount of a third data stream stored in a buffer, a channel bandwidth, a signal-to-noise ratio, a bit error rate, a fading rate, or the number of usable channels between the data-processing apparatus and a receiving device, where the third data stream may include a data stream previously obtained by decoding source data from the UAV and encoding the decoded data. The channel bandwidth between the data-processing apparatus and the receiving device may indicate a network condition between the data-processing apparatus and the receiving device. A relatively large channel bandwidth may indicate a relatively good network condition, and a relatively small channel bandwidth may indicate a relatively poor network condition. The signal-to-noise ratio may refer to a ratio of a signal power to a noise power. A relatively high signal-to-noise ratio may correspond to a relatively good data transmission between the data-processing apparatus and the receiving device. The bit error rate may refer to the number of bit errors per unit time. A relatively small bit error rate may correspond to a relatively good data transmission between the data-processing apparatus and the receiving device. A fading rate may refer a rate at which attenuation of a signal occurs. A relatively small fading rate may correspond to a relatively good data transmission between the data-processing apparatus and the receiving device. The number of usable channels may refer to the number of channels that can be used for wireless data communication. A relatively large number of usable channels may correspond to a relatively good data transmission between the data-processing apparatus and the receiving device.

At 183, original data is encoded to obtain a second data stream according to the encoding parameter.

The encoding parameter may be a parameter that influences an encoding process. In some embodiments, the encoding parameter may be, for example, a parameter that influences a data rate for encoding. The data rate for encoding may refer to a target data rate of encoded data.

In some embodiments, the data rate for encoding may be positively correlated with the encoding parameter. That is, if a value of the encoding parameter increases, the data rate for encoding may increase correspondingly; and if the value of the encoding parameter decreases, the data rate for encoding may decrease correspondingly. For example, the encoding parameter may include the data rate for encoding or another suitable parameter that is positively correlated with the data rate for encoding. In some other embodiments, the data rate for encoding may be negatively correlated with the encoding parameter. That is, if the value of the encoding parameter increases, the data rate for encoding may decrease; and if the value of encoding parameter decreases, the data rate for encoding may increase. For example, the encoding parameter may include a quantization parameter for encoding or another suitable parameter that is negatively correlated with the data rate for encoding.

In some embodiments, the original data may be data that can be encoded. The second data stream is an encoded data stream.

In some embodiments, determining the encoding parameter (182 in FIG. 2) may include changing the encoding parameter to decrease the data rate for encoding if the one or more factors satisfy a first preset condition.

In the embodiments that the encoding parameter includes the data rate for encoding, and the data rate for encoding may be directly reduced. In the embodiments that the encoding parameter includes a quantization parameter for encoding, the data rate for encoding may be reduced by increasing the quantization parameter for encoding.

In some embodiments, the one or more factors may include the amount of buffer space occupied by the third data stream, i.e., a stored data amount of the third data stream in the buffer, and correspondingly, the first preset condition may include the amount of buffer space occupied by the third data stream, i.e., the stored data amount of the third data stream in the buffer, being larger than a first data amount threshold, also referred to as an “upper data amount threshold value” or an “upper threshold value.” In these embodiments, determining the encoding parameter may include changing the encoding parameter to decrease the data rate for encoding if the amount of buffer space occupied by the third data stream is larger than the upper threshold value. As such, the original data may be encoded at a relatively low data rate, and hence less encoded data, i.e., the second data stream generated by encoding the original data, may be created during a same period of time.

In some embodiments, after being generated, the second data stream can be stored to the buffer. Thus, reducing the amount of second data stream generated during a certain period of time can reduce the amount of buffer space needed to store the second data stream during the certain period of time. By reducing the amount of second data stream generated during a certain period of time, the second data stream can be smoothly sent out when the network status is relatively poor, such that delay is reduced.

In some embodiments, changing the encoding parameter to decrease the data rate for encoding can include periodically checking whether an amount of buffer space occupied by stored data in the buffer is smaller than a lower limit data amount threshold, also referred to as a “decreasing-stop data amount” or a “decreasing-stop value.” The decreasing-stop value may be smaller than the upper threshold value. If the amount of buffer space occupied by the stored data is larger than or equal to the decreasing-stop value, the encoding parameter can be repeatedly changed to decrease the data rate for encoding, until the amount of buffer space occupied by the stored data is smaller than the decreasing-stop value.

That is, if, upon one checking, the amount of buffer space occupied by the stored data stream in the buffer is not smaller than the decreasing-stop value, the encoding parameter may be changed to decrease the data rate for encoding. Further, the original data can be encoded according to the changed encoding parameter, and encoded data can be stored in the buffer. Then it is checked again whether the amount of buffer space occupied by the stored data stream in the buffer is smaller than the decreasing-stop value. If not, the encoding parameter may be changed again to further decrease the data rate for encoding, and the original data may be encoded according to the further changed encoding parameter. This process may repeat until the amount of buffer space occupied by the stored data stream is smaller than the decreasing-stop value.

Consistent with the disclosure, because the second data stream may be continuously stored to the buffer and stored data stream may be continuously pushed out of the buffer, the stored data stream in the buffer may include at least a portion of the third data stream and/or a portion of the second data stream.

An amount of buffer space occupied by a data stream or a similar expression may also be referred to as a stored data amount of a data stream stored in the buffer. For example, an amount of buffer space occupied by the third data stream may also be referred to as a stored data amount of the third data stream in the buffer. As another example, an amount of buffer space occupied by the second data stream may also be referred to as a stored data amount of the second data stream in the buffer.

In some embodiments, determining the encoding parameter (182 in FIG. 2) may include changing the encoding parameter to increase the data rate for encoding if the one or more factors satisfy a second preset condition.

In the embodiments that the encoding parameter includes the data rate for encoding, the data rate for encoding may be directly increased. In the embodiments that the encoding parameter includes the quantization parameter for encoding, the data rate for encoding may be increased by reducing the quantization parameter.

In some embodiments, the one or more factors may include the one or more factors may include the amount of buffer space occupied by the third data stream, i.e., the stored data amount of the third data stream in the buffer, and correspondingly the second condition may include the amount of buffer space occupied by the third data stream being smaller than a second data amount threshold, also referred to as a “lower data amount threshold value” or a “lower threshold value.” In these embodiments, determining the encoding parameter may include changing the encoding parameter to increase the data rate for encoding if the amount of buffer space occupied by the third data stream is smaller than the lower threshold value. As such, the original data may be encoded at a relatively high data rate for encoding, and hence more encoded data stream, i.e., the second data stream generated by encoding the original data, may be created during a same period of time.

In some embodiments, after being generated, the second data stream can be stored to the buffer. Thus, increasing the amount of second data stream generated during a certain period of time can increase the amount of memory space needed to store the second data stream during the certain period of time. When the network status is relative good, by increasing the amount of second data stream generated during a certain period of time, encoding quality for encoding the original data may be improved. In the embodiments that the original data include image data, image encoding quality may be improved. Thus, image quality of further decoded image data may be improved.

In some embodiments, changing the encoding parameter to increase the data rate for encoding can include periodically checking whether an amount of buffer space occupied by stored data stream in the buffer is larger than an upper limit data amount threshold, also referred to as an “increasing-stop data amount” or an “increasing-stop value.” The increasing-stop value may be larger than the lower threshold value. If the amount of buffer space occupied by the stored data stream is smaller than or equal to the increasing-stop value, the encoding parameter can be repeatedly changed to increase the data rate for encoding, and the original data is encoded according to the changed encoding parameter, and encoded data stream is stored in the buffer, until the amount of buffer space occupied by the stored data stream is larger than the increasing-stop value.

That is, if, upon one checking, the amount of buffer space occupied by stored data stream in the buffer is not larger than the increasing-stop value, the encoding parameter may be changed to increase the data rate for encoding. Then it is checked again whether the amount of buffer space occupied by the stored data stream in the buffer is larger than the increasing-stop value. If not, the encoding parameter may be changed again to further increase the data rate for encoding, and the original data may be encoded according to the further changed encoding parameter. The process may repeat until the amount of buffer space occupied by the stored data stream is larger than the increasing-stop value.

Because the second data stream may be stored to the buffer, increasing the data rate for encoding may increase a data rate of obtaining the second data stream, and may increase a data rate of storing the second data stream to the buffer. Further, decreasing the data rate for encoding may decrease a data rate of obtaining the second data stream, and may decrease a data rate of storing the second data stream to the buffer.

As described above, in some embodiments, determining the encoding parameter (182 in FIG. 2) may include changing the encoding parameter to decrease the data rate for encoding if the one or more factors satisfy a first preset condition.

In some embodiments, the one or more factors may include a channel bandwidth between the data-processing apparatus and the receiving device, and correspondingly, the first preset condition may include the channel bandwidth being smaller than a lower bandwidth boundary value. In these embodiments, determining the encoding parameter may include changing the encoding parameter to decrease the data rate for encoding if the channel bandwidth is smaller than the lower bandwidth boundary value.

In some embodiments, after being generated, the second data stream can be stored to the buffer.

In some embodiments, changing the encoding parameter to decrease the data rate for encoding may include periodically checking whether the data rate for encoding is smaller than a decreasing-stop data rate. If the data rate for encoding is not smaller than the decreasing-stop data rate, the encoding parameter can be repeatedly changed to decrease the data rate for encoding and the original data may be encoded according to the further changed encoding parameter, until the data rate for encoding is smaller than the decreasing-stop data rate.

In some embodiments, the decreasing-stop data rate may include a predetermined value. Further, the decreasing-stop data rate may have a correspondence with the channel bandwidth, and may be set according to a correspondence between the decreasing-stop data rate and the channel bandwidth.

When the channel bandwidth is smaller than the lower bandwidth boundary value, it may indicate that a current network condition is relatively poor. The encoding parameter may be changed to decrease the data rate for encoding, such that the data rate for encoding may match the network condition. Accordingly, the data stream in the buffer can be sent out smoothly when the network condition is relatively poor.

In some embodiments, as described above, determining the encoding parameter (182 in FIG. 2) may include changing the encoding parameter to increase the data rate for encoding if the one or more factors satisfy a second preset condition.

In some embodiments, the one or more factors may include a channel bandwidth between the data-processing apparatus and the receiving device; and correspondingly, the second preset condition may include the channel bandwidth being larger than an upper bandwidth boundary value. In these embodiments, determining the encoding parameter may include changing the encoding parameter to increase the data rate for encoding if the channel bandwidth is larger than the upper bandwidth boundary value.

In some embodiments, after being generated, the second data stream can be stored to the buffer.

In some embodiments, changing the encoding parameter to increase the data rate for encoding may include periodically checking whether the data rate for encoding is larger than an increasing-stop date rate. If the data rate for encoding is not larger than an increasing-stop date rate, the encoding parameter can be repeatedly changed to increase the data rate for encoding and the original data may be encoded according to the changed encoding parameter, until the data rate for encoding is larger than the increasing-stop data rate.

In some embodiments, the increasing-stop data rate may include a predetermined value. Further, the increasing-stop data rate may have a correspondence with the channel bandwidth, and may be set according to a correspondence between the increasing-stop data rate and the channel bandwidth.

When the channel bandwidth is larger than the upper bandwidth boundary value, it may indicate that a current network condition is relatively good, and the data stream in the buffer can be sent out smoothly. The encoding parameter may be changed to increase the data rate for encoding, such that the data rate for encoding can match with the network condition and encoding quality can be improved.

According to methods consistent with the present disclosure, if the amount of buffer space occupied by the third data stream deviates from a range between a lower threshold value and an upper threshold value, the deviation can be suppressed.

In some embodiments, the encoding parameter may be the data rate for encoding or the quantization parameter. In these embodiments, determining the encoding parameter according to the one or more factors may include determining the data rate for encoding or the quantization parameter according to the one or more factors, and encoding the original data to generate the second data stream according to the encoding parameter may include encoding the original data to generate the second data stream according to the data rate for encoding or the quantization parameter. Further, determining the encoding parameter according to the amount of buffer space occupied by the third data stream may include determining the data rate for encoding according to the amount of buffer space occupied by the third data stream. Further, encoding the original data to obtain the second data stream according to the encoding parameter may include encoding the original data to obtain the second data stream according to the data rate for encoding or the quantization parameter. That is, the data-processing apparatus may determine the data rate for encoding or the quantization parameter according to the amount of buffer space occupied by the third data stream, and encode the original data to obtain the second data stream according to the data rate for encoding.

In some embodiments, encoding the original data to obtain the second data stream may include encoding the original data and auxiliary information to obtain the second data stream. That is, the data-processing apparatus may encode the original data and auxiliary information to obtain the second data stream. The auxiliary information may include, for example, at least one of text information or time information.

The text information may include various types of text information. For example, the text information may include at least one of location information provided by a user, an area of a target region, an identification of a target person, or an identification of a plate number. In some embodiments, as described above, the source data may be provided by a data source. In these embodiments, the text information may include at least one of location information of the data source, a distance between a target object and the data source, the location information provided by the user, the area of the target region, the identification of the target person, or the identification of the plate number. In some embodiments, the data source may include an unmanned aerial vehicle, and the location information of the data source may include location information of the unmanned aerial vehicle.

In some embodiments, the time information can include a time stamp. In some embodiments, the time stamp can indicate a time specified by the user or obtained from a cellular network or a satellite positioning device. In the embodiments that the original data is obtained by processing the source data, the time stamp can indicate a time at which the source data is obtained, such as the time at which the data source obtains the source data.

In some other embodiments, the auxiliary information may include at least one of location information for indicating a location where the source data are obtained or time information for indicating a time when the source data are obtained.

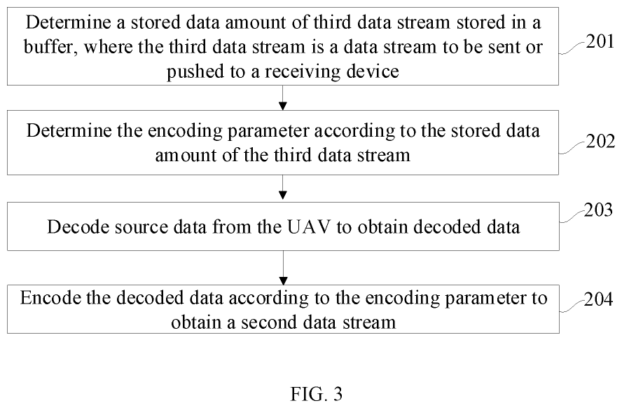

The present disclosure provides a data processing method. FIG. 3 illustrates a flowchart of another exemplary data processing method according to various disclosed embodiments of the present disclosure. With reference to FIG. 3, the method is described below.

At 201, a stored data amount of third data stream stored in a buffer is determined, where the third data stream is a data stream to be sent or pushed to a receiving device.

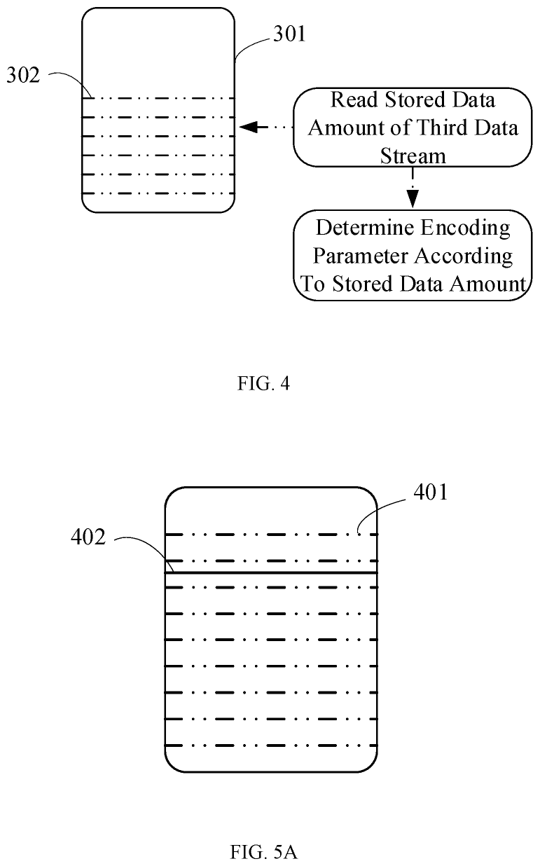

In some embodiments, an executing entity of the method may include the data-processing apparatus described above, such as a control terminal for a UAV. For example, the control terminal may perform the method through a processor of the control terminal. FIG. 4 illustrates a schematic diagram illustrating a determination of an encoding parameter according to various disclosed embodiments of the present disclosure. As shown in FIG. 4, the control terminal receives the source data sent from the UAV. The control terminal, e.g., through the processor of the control terminal, can decode the source data to obtain the original data. The control terminal includes a buffer 301 for storing data, such as encoded data. When encoding the original data, the processor can determine a stored data amount 302 of the third data stream, e.g., as an image data stream, stored in the buffer 301. The third data stream may include data stream previously obtained by decoding previous source data from the UAV and encoding the decoded data. The third data stream may be stored in the buffer 301 and wait to be sent to a receiving device. In some embodiments, the third data stream may be read from the buffer 301 and sent to the receiving device by a communication interface. The communication interface may also be referred to as a transmitter.

At 202, the encoding parameter is determined according to the stored data amount of the third data stream.

In some embodiments, the stored data amount of the third data stream stored in the buffer may indicate a current network condition between the control terminal and the receiving device. When the stored data amount of the third data stream stored in the buffer is relatively small, it may indicate that the current network condition between the control terminal and the receiving device may be relatively good, and the data stream stored in the buffer may be sent smoothly to the receiving device. When the stored data amount of the third data stream stored in the buffer is relatively large, it may indicate that the current network condition between the control terminal and the receiving device may be relatively poor, and the data stream stored in the buffer may not be sent smoothly to the receiving device, and a relatively large portion of the data stream may remain in the buffer. The processor of the control terminal may determine the encoding parameter according to the stored data amount of the third data stream, and the encoding parameter may match the current network condition.

In some embodiments, the buffer may be a portion of a memory of the data-processing apparatus, or may include a stand-alone storage unit separated from the memory of the data-processing apparatus. The buffer may include, for example, a cache or a double data rate (DDR) memory. The third data stream may be data stream to be pushed by the data-processing apparatus to a receiving device. The processor of the data-processing apparatus may control a transmitter of the data-processing apparatus to push the third data stream stored in the buffer to the receiving device.

In some embodiments, the receiving device can be, for example, a server.

In the present disclosure, the manner of pushing the third data stream to the receiving device is not restricted. In some embodiment, at a certain time point, an entire amount of the third data stream that is available in the buffer at the time point may be pushed to the receiving device. In some other embodiments, at a certain time point, a portion of the third data stream that is available in the buffer at the time point may be pushed to the receiving device. One or more other portions of the third data stream that is available in the buffer at the time point may be pushed to the receiving device later.

At 203, source data from the UAV is decoded to obtain decoded data.

In some embodiments, the control terminal may receive the source data sent from the UAV. The source data from the UAV may include data that is obtained by encoding original data according to an original-data encoding parameter. Thus, the source data may include the original data or data associated with original data. In order to send the data obtained from the UAV to the receiving device, the processor of the control terminal may decode the source data from the UAV to obtain decoded data, i.e., the original data, that conforms to, for example, a H264 format or a H265 format, and may further encode the original data to another data stream that conforms to a communication protocol and above-described network conduction between the control terminal and the receiving device.

At 204, the decoded data is encoded according to the encoding parameter to obtain a second data stream.

In some embodiments, the processor may encode the decoded data, i.e., the original data, according to the encoding parameter determined in process 202, to obtain the second data stream. Because the stored data amount of the third data stream in the buffer may indicate a current network condition between the control terminal and the receiving device, the encoding parameter determined according to the stored data amount of the third data stream can allow the second data stream obtained by encoding to better fit the current network condition.

The execution order of process 201, process 202, and process 203 are not restricted. Process 201, process 202, and process 203 may be performed one after another, may be performed simultaneously, or may be perform in another order. The execution order is not restricted, and may be adjusted according to various application scenarios.

In the embodiments described above, the encoding parameter is determined according to the stored data amount of the third data stream in the buffer. In some other embodiments, the control terminal may determine the encoding parameter according to a remaining space size of the buffer. The buffer may include a buffer for storing a data stream, such as an image data stream. The remaining space size of the buffer may indicate a network condition between the control terminal and the receiving device. When the remaining space size is relatively large, it may indicate that the current network condition between the control terminal and the receiving device may be relatively good, and the data stream stored in the buffer may be sent to the receiving device smoothly. When the remaining space size is relatively small, it may indicate that the current network condition between the control terminal and the receiving device may be relatively poor, and the data stream stored in the buffer may not be sent smoothly to the receiving device.

In some embodiments, the processor of the control terminal may determine a read data amount of a data stream, e.g., an image data stream, that the communication interface reads from the buffer in a unit time period, and determine the encoding parameter according to the data amount, i.e., the read data amount. The read data amount of the data stream that the communication interface reads from the buffer in a unit time period may indicate a network condition between the control terminal and the receiving device. When the read data amount is relatively large, it may indicate that a current network condition between the control terminal and the receiving device may be relatively good, and the data stream stored in the buffer may be sent to the receiving device smoothly. When the read data amount is relatively small, it may indicate that the current network condition between the control terminal and the receiving device may be relatively poor, and the data stream stored in the buffer may not be sent smoothly to the receiving device.

In the embodiments of the present disclosure, an encoding parameter may be determined according to stored data amount of a third data stream stored in a buffer. Original data may be obtained by decoding source data from a data source, such as the UAV. The original data may be encoded according to an encoding parameter. The stored data amount of the third data stream stored in the buffer may indicate a network condition between the control terminal and the receiving device. Accordingly, the original data may be encoded according to an encoding strategy matching the network condition, such that data rate of encoding may match the network condition, to ensure a smooth transmission of data stream that is obtained by encoding the original data.

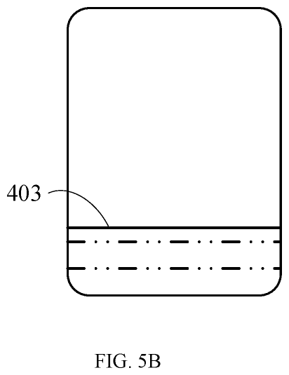

In some embodiments, determining the encoding parameter according to the stored data amount of the third data stream may include determining whether the stored data amount of the third data stream is greater than a first data amount threshold, i.e., an upper data amount threshold value, also referred to as an “upper threshold value”; and if the stored data amount of the third data stream is greater than the first data amount threshold, determining a rate-reducing encoding parameter as the encoding parameter. The rate-reducing encoding parameter can reduce a data rate of data stream obtained by encoding, i.e., a data rate for encoding. The data stream obtained by encoding can also be referred to as an encoded data stream. The data rate of the data stream obtained by encoding can also be referred to as a data rate of the encoded data stream. Further, encoding decoded data according to the encoding parameter to obtain the second data stream may include encoding the decoded data according to the rate-reducing encoding parameter to obtain the second data stream. Further, the processor may store the second data stream into the buffer. FIGS. 5A and 5B illustrates schematic diagrams for exemplary stored data amount of data stream stored in a buffer and to be sent, first data amount threshold, and lower limit data amount threshold according to various disclosed embodiments of the present disclosure. As shown in FIG. 5A, after the processor reads a stored data amount 401 of the third data stream, the processor determines whether the stored data amount 401 of the third data stream is greater than a first data amount threshold 402. When it is determined that the stored data amount 401 is greater than the first data amount threshold 402, it indicates that the current network condition is relatively poor, and a more than normal amount of data streams in the buffer are not sent. Correspondingly, the processor may determine the rate-reducing encoding parameter as the encoding parameter, and encode the decoded data according to the rate-reducing encoding parameter to reduce the data rate of the encoded data stream. For example, the processor may encode the decoded data according to the rate-reducing encoding parameter to reduce the data rate of the second data stream. In some embodiments, determining the rate-reducing encoding parameter to reduce the data rate of the encoded data stream may include determining the rate-reducing encoding parameter to reduce the data rate of the encoded data stream by a preset amount. Accordingly, when the network condition is relatively poor, the data rate of the encoded data stream may be reduced. Thus, the data stream can be sent out smoothly when the network condition is relatively poor.

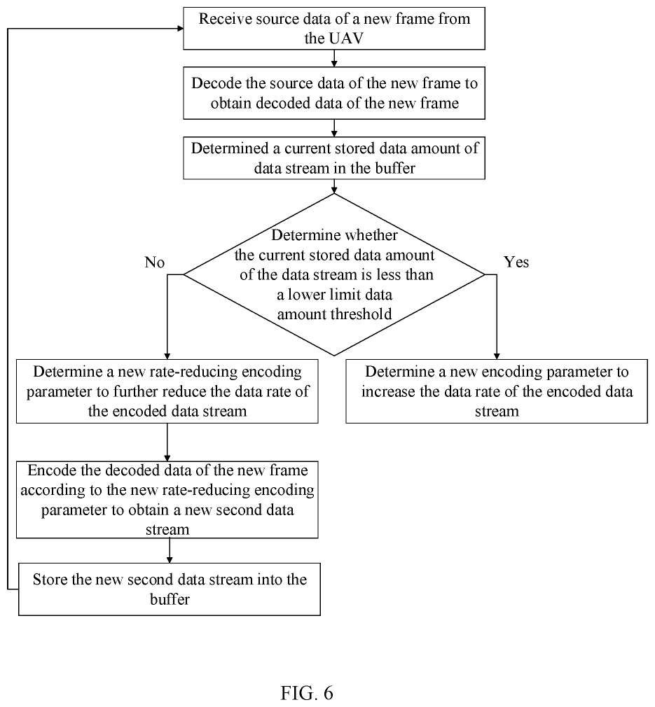

In some embodiments, the encoding parameter, e.g., the rate-reducing encoding parameter, can be repeatedly modified to further reduce the data rate of the encoded data stream until the stored data amount of the data stream is lower than a certain value. For example, the processor may further decode source data of a new frame, e.g., source image data of a new frame, obtained from the UAV. The processor may determine whether the stored data amount of the data stream is less than a lower limit data amount threshold, also referred to as a “decreasing-stop data amount” or a “decreasing-stop value.” If the stored data amount of the data stream is not less than the lower limit data amount threshold, the processor may determine a new rate-reducing encoding parameter to further reduce the data rate of the encoded data stream, and may encode the decoded data of the new frame according to the new rate-reducing encoding parameter to obtain a new second data stream. As shown in FIG. 5B, the control terminal may receive source data of a new frame, i.e., a new frame of source data, from the UAV. The control terminal may decode the source data of the new frame to obtain decoded data of the new frame. Before encoding the decoded data of the new frame, it may be determined whether a current stored data amount of data stream in the buffer is less than a lower limit data amount threshold 403. If the current stored data amount of data stream is not less than the lower limit data amount threshold 403, a new rate-reducing encoding parameter may be determined to further reduce the data rate of the encoded data stream. For example, a new rate-reducing encoding parameter may be determined to further reduce the data rate of the encoded data stream by a preset amount. The decoded data of the new frame may be encoded according to the new rate-reducing encoding parameter to obtain a new second data stream. The processor may store the new second data stream into the buffer. The above-described processes may be repeated until the stored data amount of the data stream(s) stored in the buffer is less than the lower limit data amount threshold 403. In some embodiments, when the stored data amount of the data stream(s) stored in the buffer is less than the lower limit data amount threshold 403, a new encoding parameter may be determined to increase the data rate of the encoded data stream. The decoded data of a new frame may be encoded according to the new encoding parameter. When the stored data amount of the data stream stored in the buffer is less than the lower limit data amount threshold 403, it may indicate that the current network condition is relatively good, and a new encoding parameter may be determined to increase the data rate of the encoded data stream and to improve data quality, e.g., image quality when the data stream includes an image data stream. For details of the above-described processes, reference can be made to FIG. 6. FIG. 6 illustrates a flow chart of determining an encoding parameter according to stored data amount of data stream stored in a buffer and to be sent according to various disclosed embodiments of the present disclosure.

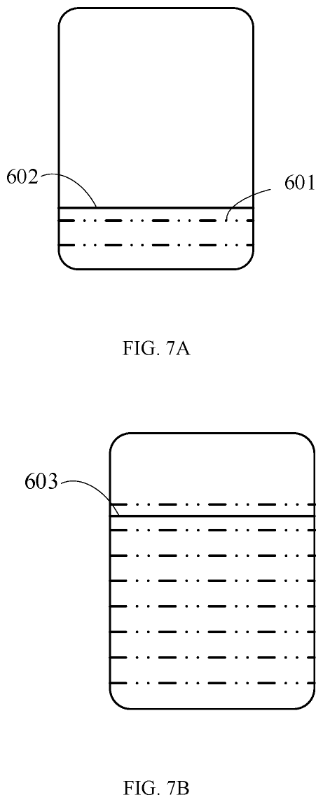

In some embodiments, determining the encoding parameter according to the stored data amount of the third data stream may include determining whether the stored data amount of the third data stream is less than a second data amount threshold, also referred to as a “lower data amount threshold value” or a “lower threshold value”; and if the stored data amount of the third data stream is less than the second data amount threshold, determining a rate-increasing encoding parameter as the encoding parameter that can increase a data rate of encoded data stream, i.e., a data rate for encoding. Further, encoding the decoded data according to the encoding parameter to obtain the second data stream may include encoding the decoded data according to the rate-increasing encoding parameter to obtain the second data stream. Further, the processor may store the second data stream into the buffer. FIGS. 7A and 7B illustrates schematic diagrams for stored data amount of data stream stored in a buffer and to be sent, second data amount threshold, and upper limit data amount threshold according to various disclosed embodiments of the present disclosure. As shown in FIG. 7A, after the processor reads a stored data amount 601 of the third data stream, the processor determines whether the stored data amount 601 of the third data stream is less than a second data amount threshold 602. When it is determined that the stored data amount 601 is less than the second data amount threshold 602, it indicates that the current network condition is relatively good, and the data stream in the buffer may be sent out smoothly. Correspondingly, the processor may determine the rate-increasing encoding parameter as the encoding parameter, and encode the decoded data according to the rate-increasing encoding parameter to increase the data rate of the encoded data stream. For example, the processor may encode the decoded data according to the rate-increasing encoding parameter to increase the data rate of the second data stream. In some embodiments, determining the rate-increasing encoding parameter to increase the data rate of the encoded data stream may include determining the rate-increasing encoding parameter to increase the data rate of the encoded data stream by a preset amount. Accordingly, when the network condition is relatively good, the data rate of the encoded data stream may be increased, and encoding quality may be improved. For example, if the data stream includes image data stream, image quality may be improved.

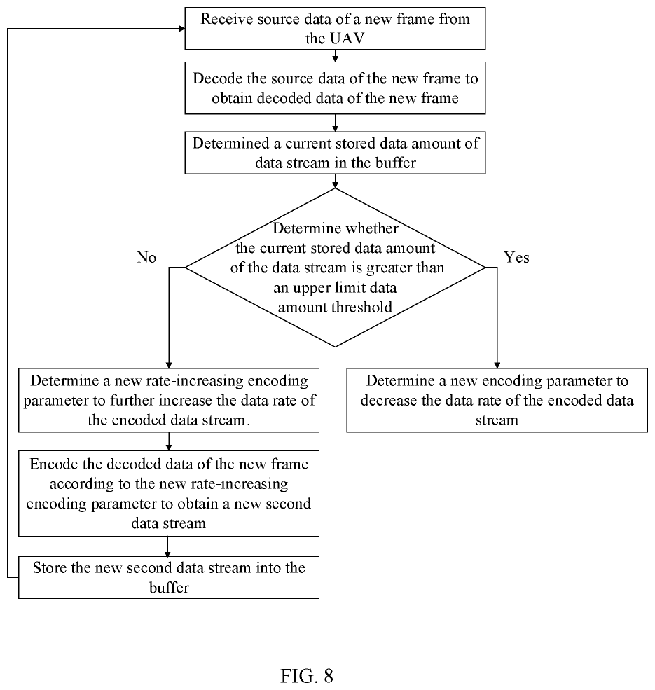

In some embodiments, the encoding parameter, e.g., the rate-increasing encoding parameter, can be repeatedly modified to further increase the data rate of the encoded data stream until the stored data amount of the data stream is greater than a certain value. For example, the processor may further decode source data of a new frame, e.g., source image data of a new frame, obtained from the UAV. The processor may determine whether the stored data amount of the data stream in the buffer is greater than an upper limit data amount threshold, also referred to as an “increasing-stop data amount” or an “increasing-stop value.” If the stored data amount of the data stream in the buffer is not greater than the upper limit data amount threshold, the processor may determine a new rate-increasing encoding parameter to further increase the data rate of the encoded data stream, and may encode the decoded data of the new frame according to the new rate-increasing encoding parameter to obtain a new second data stream and store the new second data stream in the buffer. As shown in FIG. 7B, the control terminal may receive source data of a new frame, i.e., a new frame of source data, from the UAV. The control terminal may decode the source data of the new frame to obtain decoded data of the new frame. Before encoding the decoded data of the new frame, it may be determined whether a current stored data amount of data stream in the buffer is greater than an upper limit data amount threshold 603. If the current stored data amount of the data stream is not greater than the upper limit data amount threshold 603, a new rate-increasing encoding parameter may be determined to further increase the data rate of the encoded data stream. For example, a new rate-increasing encoding parameter may be determined to further increase the data rate of the encoded data stream by a preset amount. The decoded data of the new frame may be encoded according to the new rate-increasing encoding parameter to obtain a new second data stream. The processor may store the new second data stream into the buffer. The above-described processes may be repeated until the stored data amount of the data stream stored in the buffer is greater than the upper limit data amount threshold 603. In some embodiments, when the stored data amount of the data stream stored in the buffer is greater than the upper limit data amount threshold 603, a new encoding parameter may be determined to reduce the data rate of the encoded data stream. The decoded data of a new frame may be encoded according to the new encoding parameter. As such, when the network condition is relatively poor, and data stream can still be sent out smoothly. For details of the above-described processes, reference can be made to FIG. 8. FIG. 8 illustrates another schematic view of determining an encoding parameter according to stored data amount of data stream stored in a buffer and to be sent according to various disclosed embodiments of the present disclosure.

In the embodiments described above, when the stored data amount of the data stream stored in the buffer becomes less than the lower limit data amount threshold, the new encoding parameter is determined to increase the data rate of the encoded data stream. In some other embodiments, when the stored data amount of the data stream stored in the buffer becomes less than the lower limit data amount threshold, the encoding parameter can be kept unchanged to maintain the data rate of the encoded data stream. For example, if the lower limit data amount threshold is greater than the second data amount threshold, and if the stored data amount of the data stream stored in the buffer becomes less than the lower limit data amount threshold but is still greater than the second data amount threshold, the encoding parameter can be kept unchanged to maintain the data rate of the encoded data stream.

Similarly, in the embodiments described above, when the stored data amount of the data stream stored in the buffer becomes greater than the upper limit data amount threshold, the new encoding parameter is determined to reduce the data rate of the encoded data stream. In some other embodiments, when the stored data amount of the data stream stored in the buffer becomes greater than the upper limit data amount threshold, the encoding parameter can be kept unchanged to maintain the data rate of the encoded data stream. For example, if the upper limit data amount threshold is less than the first data amount threshold, and if the stored data amount of the data stream stored in the buffer becomes greater than the upper limit data amount threshold but is still less than the first data amount threshold, the encoding parameter can be kept unchanged to maintain the data rate of the encoded data stream.

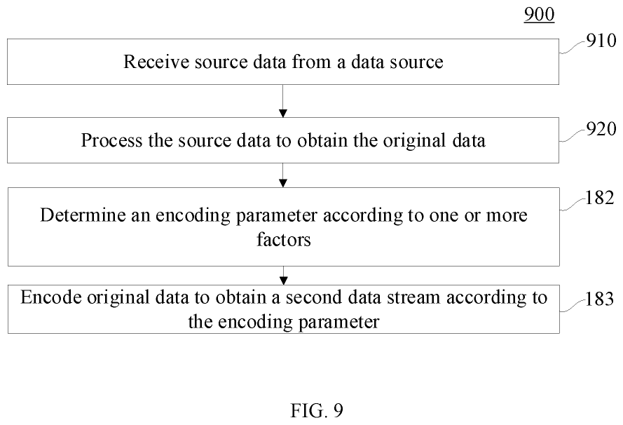

FIG. 9 illustrates a flow chart of another exemplary data processing method 900 according to various disclosed embodiments of the present disclosure. The data processing method 900 is similar to the data processing method 180 described above, except that the data processing method 900 further includes processes 910 and 920, as described below.

At 910, source data is received from a data source. As described above, the data-processing apparatus may receive the source data from a data source. The data source may include, for example, a camera or an unmanned vehicle. Correspondingly, receiving the source data from the data source may include receiving the source data from the camera or the unmanned vehicle. The unmanned vehicle may include, for example, a ground-based unmanned vehicle or an unmanned aerial vehicle, such as the UAV 11 shown in FIG. 1. Correspondingly, receiving the source data from the unmanned vehicle may include receiving the source data from the ground-based unmanned vehicle or the unmanned aerial vehicle. The source data may be in a form of data stream. That is, the source data may include a source data stream. Correspondingly, the source data stream may be received from the data source. In some embodiments, before the data source sends the source data stream to the data-processing apparatus, the data source may encode original data according to an original-data encoding parameter to obtain the source data steam. The source data stream may contain the original data or data associated with the original data. In some embodiments, the original-data encoding parameter may be different from the encoding parameter used in the data-processing apparatus. In this disclosure, the original-data encoding parameter is also referred to as a “first encoding parameter” and the encoding parameter used in the data-processing apparatus is also referred to as a “second encoding parameter.”

Further, the source data stream may contain the original data or data associated with the original data.

At 920, the source data is processed to obtain the original data.

In some embodiments, processing the source data to obtain the original data may include decoding the source data to obtain the original data. The original data may then be further processed, for example, encoded, to obtain the second data stream according to the encoding parameter as described above. Further, the original data and auxiliary information may be encoded together, as described above.

In some embodiments, the data source may include an unmanned aerial vehicle. Correspondingly, the data-processing apparatus may receive the source data from the unmanned aerial vehicle. Further, the data-processing apparatus may decode the source data to obtain the original data. That is, receiving the source data from the data source (910 in FIG. 9) may include receiving the source data from the unmanned aerial vehicle. Further, processing the source data to obtain the original data (920 in FIG. 9) may include decoding the source data to obtain the original data.

As the source data may be in a form of data stream, correspondingly, a source data stream may be received from a data source, and the source data stream may be processed to obtain the original data.

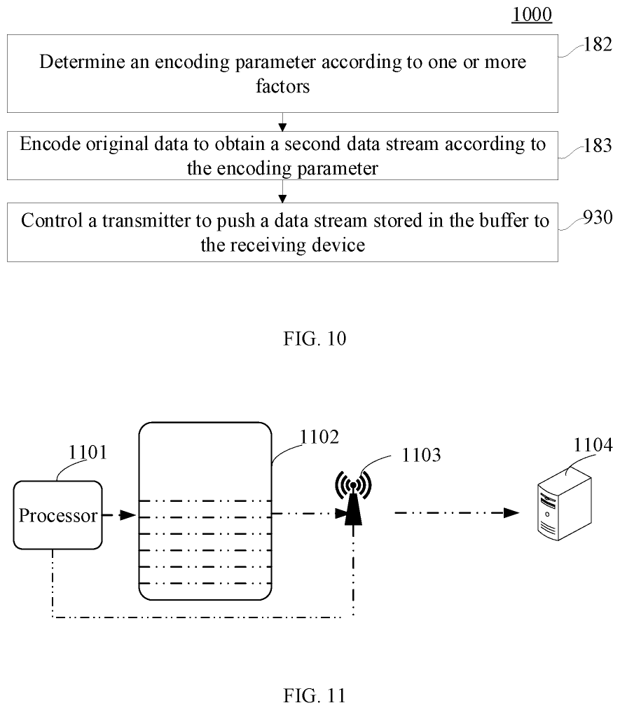

FIG. 10 illustrates a flow chart of another exemplary data processing method 1000 according to various disclosed embodiments of the present disclosure. The data processing method 1000 is similar to the data processing method 180 described above, except that the data processing method 1000 further includes process 930, as described below.

At 930, a transmitter is controlled to push a data stream stored in the buffer to the receiving device. The transmitter can be, for example, a communication interface. As described above, the receiving device can be, for example, a server. The data stream stored in the buffer may include data stream that has been encoded according to a method consistent with the disclosure, such as one of the above-described exemplary methods. For example, the data stream stored in the buffer may include at least a portion of the third data stream and/or at least a portion of the second data stream. In the present disclosure, the manner of controlling the transmitter to push the data stream stored in the buffer to the receiving device is not restricted. In some embodiment, at a certain time point, an entire amount of the data stream stored in the buffer that is available at the time point may be pushed to the receiving device. In some other embodiments, at a certain time point, a portion of the data stream stored in the buffer that is available in the buffer at the time point may be pushed to the receiving device. One or more other portions of the data stream stored in the buffer that is available in the buffer at the time point may be pushed to the receiving device later.

FIG. 11 illustrates a schematic view of example devices involved in the transmission of a data stream stored in a buffer according to various disclosed embodiments of the present disclosure. As shown in FIG. 11, a processor 1101 may store a second data stream into a buffer 1102 after the second data stream is obtained by encoding. The processor 1101 may control a communication interface 1103 to send, e.g., push, a data stream stored in the buffer 1102 to a receiving device 1104, e.g., a server.

To push the data stream stored in the buffer to the receiving device, a push address may be needed to specify a destination for the data stream. In some embodiments, an address segment, such as a push address segment, from a receiving device may be received, and the push address may be determined according to the address segment. Controlling the communication interface to send the data stream stored in the buffer to the receiving device may include controlling the communication interface to send the data stream stored in the buffer to the receiving device according to the push address. In some embodiments, before the control terminal sends the data stream stored in the buffer to the receiving device, the control terminal may receive the address segment sent from the receiving device. The control terminal may determine the push address according to the address segment. The push address may indicate a storage space address in the receiving device such as a server. The control terminal may control the communication interface to send the data stream stored in the buffer to the receiving device according to the push address. The data stream may be stored in a target storage space of the receiving device indicated by the push address.

Further, the control terminal may obtain locally stored authentication information. Determining the push address according to the address segment may include determining the pushing address according to the address segment and the authentication information. For example, the control terminal may obtain the authentication information stored in a local storage device. The authentication information may include at least one of account information or password information. The password information can also be referred to as key information. In some embodiments, the account information and the password information may include account information and password information registered to the receiving device by the user. Further, the account information and password information may be set by the user. In some embodiments, before the control terminal sends the data stream stored in the buffer to the receiving device, the control terminal may receive the address segment sent from the receiving device. The control terminal may determine the push address according to the authentication information and the address segment, and may control the communication interface to send the data stream stored in the buffer to the receiving device according to the push address. For example, if the received address segment sent from the receiving device is rtmp://100.100.1.100:1935, the control terminal may obtain locally stored account information “account” and password information “key”, and may determine that the push address is rtmp://account@key:100.100.1.100:1935 according to the address segment, the account information, and the key information. By using the address segment and the authentication information to determine the push address, the push address may not be leaked even if the address segment sent from the receiving device is maliciously intercepted. Accordingly, a leakage of the push address may be prevented, and security of the push address may be ensured.

Further, receiving the push address segment from the receiving device may include receiving the push address segment from the receiving device after an authentication with the server is completed. In some embodiments, the control terminal may perform an authentication with the receiving device. After the authentication is performed between the control terminal and the receiving device, the receiving device may send the address segment to the control terminal. The control terminal may determine, according to the address segment obtained from the receiving device, the push address.

In some embodiments, controlling the communication interface to send the data stream stored in the buffer to the receiving device according to the push address may include: controlling the communication interface to send the data stream stored in the buffer to the receiving device according to the push address within a valid period; or controlling the communication interface to start to send the data stream stored in the buffer to the receiving device according to the push address within a valid period. In some embodiments, the control terminal may need to control the communication interface to send the data stream stored in the buffer to the receiving device within a valid period, and the receiving device may accept or obtain the data stream. If the control terminal controls the communication interface to send the data stream stored in the buffer to the receiving device outside the valid period, the receiving device may refuse to accept the data stream sent from the control terminal. Accordingly, the control terminal can only send the data stream to the receiving within the valid period. Outside the valid period, even if the push address has been leaked, other control terminals can be prevented from maliciously sending data or data stream to the receiving device according to the push address. In some other embodiments, the control terminal may need to control the communication interface to start, within a valid period, to send the data stream stored in the buffer to the receiving device. If the control terminal starts, within the valid period, to send the data stream to the receiving device, the receiving device may accept or obtain the data stream. If the control terminal starts, outside the valid period, to send the data stream to the receiving device, the receiving device may refuse to accept the data stream from the control terminal.

Further, the valid period may be provided by the receiving device. In some embodiments, the receiving device may send indication information of the valid period to the control terminal, and the control terminal may receive and parse the indication information of the valid period to determine the valid period.

In some embodiments, auxiliary information may be obtained, and encoding the decoded data according to the encoding parameter to obtain the second data stream may include encoding the decoded data and the auxiliary information according to the encoding parameter to obtain the second data stream. In some embodiments, the control terminal may obtain the auxiliary information, and the auxiliary information may include at least one of location information for indicating a location where the source data are obtained or time information for indicating a time when the source data are obtained. In conventional technologies, the source data or source data stream sent from a UAV to the control terminal may not include the location information and the time information. Thus, the remote terminal cannot determine, directly according to the data obtained from the receiving device, where the data is obtained by the UAV and/or when the data is obtained by the UAV. The control terminal may encode the auxiliary information and the decoded data together to obtain the second data stream. Accordingly, the second data stream may include the location information, the time information and the like, and a user at the remote terminal may know the location information and the time information associated with the source data. In some embodiments, the auxiliary information may also include sound information. The sound information may include, for example, sound information for explaining or introducing the source data. The sound information may be collected, for example, by the UAV or the control terminal. The control terminal may encode the sound information and the decoded data together to obtain the second data stream. That is, the control terminal may encode the sound information and the original data together to obtain the second data stream. Accordingly, the second data stream may include the sound information, and the user at the remote terminal may obtain the sound information.

Further, obtaining the auxiliary information may include detecting edit operation by a user associated with the auxiliary information, and determining the auxiliary information according to the edit operation. In some embodiments, the control terminal may include an interactive interface, and the interactive interface may detect the edit operation by the user associated with the auxiliary information. The possessor may determine the auxiliary information according to the edit operation associated with the auxiliary information. As such, the user can set the auxiliary information, which can be encoded into the data to satisfy different needs.

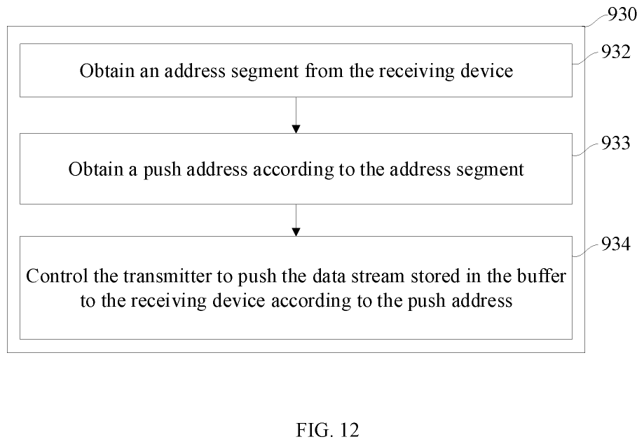

FIG. 12 illustrates a flow chart of an example of the data pushing process 930 according to various disclosed embodiments of the present disclosure.

At 932, an address segment is obtained from the receiving device.

In some embodiments, before the address segment is obtained from the receiving device, an authentication may be performed with the receiving device. That is, the data-processing apparatus may perform an authentication with the receiving device. After the data-processing apparatus completes the authentication with the receiving device, the address segment may be obtained from the receiving device.

At 933, a push address is obtained according to the address segment. That is, the data-processing apparatus may obtain the push address according to the address segment. In some embodiments, the push address may include, for example, the address segment. In some other embodiments, the push address may include, for example, the address segment and authentication information. Correspondingly, obtaining the push address according to the address segment may include obtaining the push address according to the address segment and the authentication information. In some embodiments, the authentication information may be stored locally. In some other embodiments, the authentication information may be obtained from another device, such as a UAV wirelessly communicating with the data-processing apparatus.

In some embodiments, the authentication information may include at least one of a locally stored account or a locally stored password, i.e., a locally stored key. Correspondingly, obtaining the push address according to the address segment and the authentication information may include combining the address segment and at least one of the locally stored account or the locally stored key to form the push address. The locally stored account may be, for example, an account that has been previously registered with the receiving device and stored on the data-processing apparatus. The locally stored key may be, for example, a key for the account registered with the receiving device that has been stored on the data-processing apparatus. A third party that obtains the address segment may not be able to obtain the entire push address without knowing the locally stored account and the locally stored key. Therefore, combining the address segment, the locally stored account, and the locally stored key to form the push address may improve security of controlling the transmitter to push the data stream stored in the buffer to the receiving device according to the push address.

For example, if the address segment is “:rtmp://100.100.1.100:1935”, the locally stored account is “account1”, the locally stored key is “key1”, and the push address is formed by combining the address segment, the locally stored account, and the locally stored key, the push address may be “stmp://account1@key1:100.100.1.100:1935” accordingly.

At 934, the transmitter is controlled to push the data stream stored in the buffer to the receiving device according to the push address.

In some embodiments, as described above, the receiving device may include, for example, a server. Correspondingly, performing the authentication with the receiving device may include performing the authentication with the server, obtaining the address segment from the receiving device may include obtaining the address segment from the server, and controlling the transmitter to push the data stream stored in the buffer to the receiving device according to the push address may include controlling the transmitter to push the data stream stored in the buffer to the server according to the push address.

In some embodiments, controlling the transmitter to push the data stream stored in the buffer to the receiving device according to the push address may include controlling the transmitter to push the data stream stored in the buffer to the receiving device according to the push address within a valid period. The valid period may be provided or specified by the receiving device, e.g., the server. The data-processing apparatus may push the data stream stored in the buffer to the receiving device according to the push address within the valid period. That is, the data-processing apparatus may control the transmitter of the data-processing apparatus to push the data stream stored in the buffer to the receiving device according to the push address within the valid period. If the data-processing apparatus controls the transmitter of the data-processing apparatus to push the data stream stored in the buffer to the receiving device according to the push address outside the valid period, the receiving device may refuse to accept the data stream.

In some other embodiments, controlling the transmitter to push the data stream stored in the buffer to the receiving device according to the push address may include controlling the transmitter to start to push the data stream stored in the buffer to the receiving device according to the push address within a valid period. The valid period may be provided or specified by the receiving device, e.g., the server. That is, the data-processing apparatus may start to push the data stream stored in the buffer to the receiving device according to the push address within the valid period, i.e., the time for starting to push the data stream stored in the buffer to the receiving device may be within the valid period. For example, the data-processing apparatus may, e.g., through a processor, control the transmitter of the data-processing apparatus to start, within the valid period, to push the data stream stored in the buffer to the receiving device according to the push address.

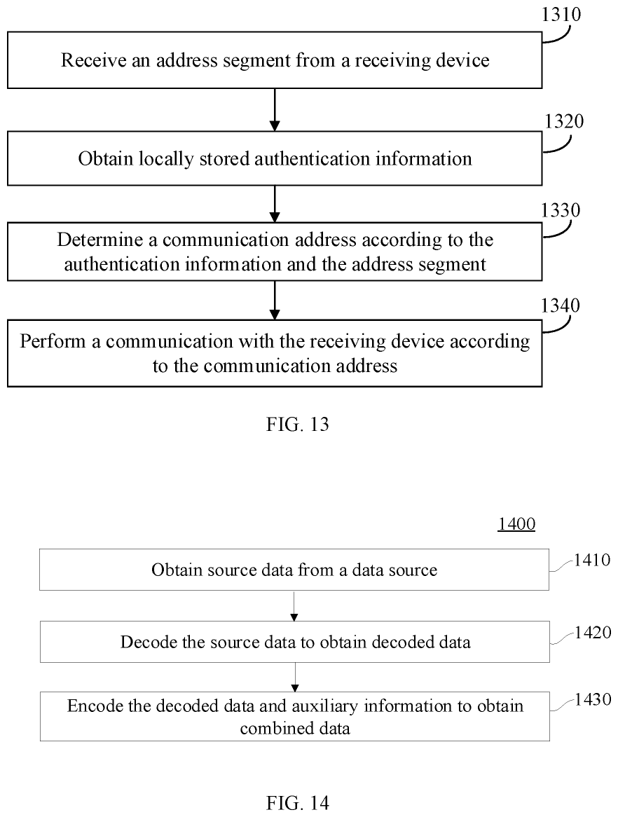

The present disclosure provides a communication method, such as a data transmission method. FIG. 13 illustrates a flowchart of an exemplary communication method according to various disclosed embodiments of the present disclosure. With reference to FIG. 13, the method is described below.

At 1310, an address segment from a receiving device is received.

In some embodiments, the executing entity of the method in the present disclosure may include a data-processing apparatus, such as a control terminal for a UAV, or a UAV. In some embodiments, the executing entity of the method may include a processor of the control terminal. In some embodiments, the control terminal may receive data sent from the UAV, and may receive an address segment sent from the receiving device before sending the data to the receiving device.

In some embodiments, receiving the address segment sent from the receiving device may include receiving the address segment sent from the receiving device after performing an authentication with the receiving device. The control terminal may perform an authentication with the receiving device and, after the control terminal completes the authentication with the receiving device, the receiving device may send the address segment to the control terminal and the control terminal may receive, i.e., obtain, the address segment sent from the receiving device.

The control terminal may determine a communication address, e.g., a push address, according to the address segment. A push address may indicate a storage space address in the receiving device such as a server. The control terminal may control a communication interface to send the data that has been obtained from the UAV to the receiving device according to the communication address.

At 1320, locally stored authentication information is obtained.

For example, the control terminal may obtain the authentication information stored in a local storage device. For example, the authentication information may include at least one of account information or password information. The locally stored authentication information may include at least one of locally stored account information or locally stored password information.

In some embodiments, the account information and the password information may include account information and password information registered to the receiving device by the user. Further, the account information and password information may be set by the user. Account information can include an account. Password information can include a password, a key, or key information.

In some embodiments, the authentication information may be obtained from another device. For example, the authentication information may be obtained from the UAV communicating with the control terminal.

At 1330, a communication address is determined, i.e., obtained, according to the authentication information and the address segment.

In some embodiments, before sending the data obtained from the data source such as a UAV to the receiving device, the control terminal may determine the communication address according to the authentication information and the address segment. Accordingly, security of the communication address may be ensured. The data obtained from the UAV may include, for example, image data from the UAV.

At 1340, a communication with the receiving device is performed according to the communication address. That is, the control terminal may communicate with the receiving device according to the communication address.

In some embodiments, communicating with the receiving device according to the communication address may include controlling the transmitter to send, i.e., to push, data to the receiving device according to the communication address. Further, communicating with the receiving device according to the communication address may include controlling the transmitter to send data obtained from a data source to the receiving device according to the communication address.

In some embodiments, data that is sent may include data from the UAV, and/or data from another data source, and/or data in a local storage. The data can be, for example, image data.

In the scenarios that the data includes data sent from the UAV, after obtaining the data sent from the UAV, the control terminal may control the transmitter to send the data to the receiving device according to the communication address. That is, communicating with the receiving device according to the communication address may include controlling the transmitter to send data from the UAV to the receiving device according to the communication address.

In some embodiments, controlling the transmitter to send the data obtained from a data source to the receiving device according to the communication address may include: controlling the transmitter to send, within a valid period, the data obtained from the data source to the receiving device according to the communication address; or controlling the transmitter to start, within a valid period, to send the data obtained from the data source to the receiving device according to the communication address. In some embodiments, the valid period may be provided by the receiving device.

FIG. 14 illustrates a flow chart of another exemplary data processing method 1400 according to various disclosed embodiments of the present disclosure. The data processing method 1400 can be implemented in, for example, the data-processing apparatus. As shown in FIG. 14, at 1410, source data is obtained from a data source. The source data may include, for example, image data. The data source may include, for example, an unmanned aerial vehicle or a camera.

In some embodiments, data of various types, such as the source data or image data, may be in a form of data stream. For example, the source data may include or be in a form of a source data stream, and the image data may include or be in a form of an image data stream.

In some embodiments, image data from the unmanned aerial vehicle may include data of one or more still pictures or data of one or more videos containing moving pictures obtained by the unmanned aerial vehicle through a camera, i.e., a photographing device, carried thereon. Further, the data-processing apparatus, may obtain, i.e., receive, the image data from the unmanned aerial vehicle.

At 1420, the source data is decoded to obtain decoded data.

In some embodiments, the source data may include image data, and correspondingly, the decoded data may include decoded image data.

At 1430, the decoded data and auxiliary information are encoded to obtain combined data. In some embodiments, the combined data may be in a form of data stream.

In some embodiments, the auxiliary information may be obtained by detecting edit operation by a user associated with the auxiliary information, and determining the auxiliary information according to the edit operation.

In some embodiments, the auxiliary information may include, for example, at least one of text information or time information. Further, the text information may include at least one of location information of the data source (for indicating, e.g., a location where the source data are obtained), location information provided by a user, a distance between a target object and the data source, an area of a target region, an identification of a target person, or an identification of a plate number. Further, the time information may include a time stamp indicating a time at which the source data is obtained by the data source or a time specified by a user.

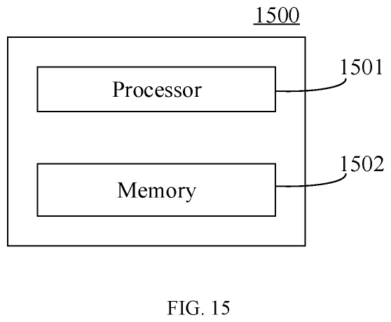

The present disclosure provides a data-processing apparatus for performing a method consistent with the disclosure, such as any one of the above-described methods. FIG. 15 illustrates a block diagram of an exemplary hardware configuration of an exemplary data-processing apparatus 1500 according to various disclosed embodiments of the present disclosure. As shown in FIG. 15, the data-processing apparatus 1500 includes a processor 1501 and a memory 1502. The memory 1502 stores instructions for execution by the processor 1501 to perform a method consistent with the disclosure, such as one of the exemplary methods described above. In some embodiments, the processor 1501 may include any suitable hardware processor, such as a microprocessor, a micro-controller, a central processing unit (CPU), a graphic processing unit (GPU), a network processor (NP), a digital signal processor (DSP), an application specific integrated circuit (ASIC), a field-programmable gate array (FPGA), or another programmable logic device, discrete gate or transistor logic device, discrete hardware component. In some embodiments, the memory 1502 may include a non-transitory computer-readable storage medium, such as a random access memory (RAM), a read only memory, a flash memory, a hard disk storage, or an optical medium.

The data-processing apparatus 1500 may include a buffer for storing data, e.g., data to be pushed to a receiving device. The buffer may be a portion of the memory 1502, or may include a stand-alone storage unit separated from the memory 1502. The buffer may include, for example, a cache or a double data rate (DDR) memory. The data-processing apparatus 1500 may include other suitable structures not shown in FIG. 15, for example, a user input interface. The user input interface may allow a user to interact with the data-processing apparatus 1500. The user input interface may include, for example, a touch screen, a keyboard, a mouse, and/or a joystick.

In some embodiments, the data-processing apparatus 1500 can generate the source data via one or more components of the data-processing apparatus 1500. For example, the data-processing apparatus 1500 may include, e.g., a camera, a camcorder, or a smart device (such as a smart phone or a tablet), that includes an image capturing component for generating image data as the source data. As used in this disclosure, “image data” may refer to data of one or more still pictures or data of one or more videos containing moving pictures. In some other embodiments, the data-processing apparatus 1500 can receive the source data from a data source. The data source can be, for example, an unmanned vehicle, e.g., an unmanned aerial vehicle, a camera, or camcorder that can generate image data as the source data. In these embodiments, the data-processing apparatus 1500 can further includes a communication circuit for communicating with the data source and receiving the source data.

In some embodiments, the instructions stored in the memory, when executed by the processor, may cause the processor to determine an encoding parameter according to one or more factors, and to encode original data to obtain second data stream according to the encoding parameter.

The one or more factors may include factors associated with the data-processing apparatus. The one or more factors may include at least one of a stored data amount of third data stream stored in a buffer, a channel bandwidth, a signal-to-noise ratio, a bit error rate, a fading rate, or the number of usable channels between the data-processing apparatus and a receiving device, where the third data stream may include data stream previously obtained by decoding a data stream from the UAV and encoding the decoded data.

In some embodiments, the instructions may further cause the processor to receive source data from a data source, and to process the source data to obtain original data.

In some embodiments, the instructions may also cause the processor to control a transmitter to push data stream stored in the buffer to a receiving device.

For details of the functions of the above-described devices or functions of the modules of a device, references can be made to method embodiments described above, descriptions of which are not repeated here.

The flowchart and block diagrams in the figures illustrate the architecture, functionality, and operation of possible implementations of systems and methods according to various embodiments of the present disclosure. In this regard, each block in the flowchart or block diagrams may represent a module, segment, or portion of instructions, which comprises one or more executable instructions for implementing the specified logical function(s). It should be noted that, in some alternative implementations, the functions noted in the block may occur in an order different from the order noted in the figures. For example, two blocks shown in succession may, in fact, be executed substantially concurrently, or the blocks may sometimes be executed in the reverse order, depending upon the functionality involved. For example, some blocks may sometimes be skipped or not executed depending upon the functionality involved. It should also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A data processing method comprising:
receiving a first data stream from a data source, the first data stream being obtained by encoding original data according to a first encoding parameter;
decoding the first data stream to obtain the original data;
determining, at a data-processing apparatus remote from the data source, a second encoding parameter according to one or more factors that are associated with the data-processing apparatus; and
encoding the original data to obtain a second data stream according to the second encoding parameter.

2. The data processing method according to claim 1, wherein the one or more factors include at least one of a stored data amount of third data stream stored in a buffer, a channel bandwidth, a signal-to-noise ratio, a bit error rate, a fading rate, or the number of usable channels between the data-processing apparatus and a receiving device, the third data stream being data stream to be pushed to a receiving device.

3. The data processing method according to claim 1, wherein determining the second encoding parameter includes:
changing the second encoding parameter to decrease a data rate for encoding if the one or more factors satisfy a first preset condition.

4. The data processing method according to claim 3, wherein:
the one or more factors include a stored data amount of a third data stream stored in a buffer; and
determining the second encoding parameter includes:
changing the second encoding parameter to decrease a data rate for encoding if the stored data amount of the third data stream is larger than an upper threshold value.

5. The data processing method according to claim 4, further comprising:
storing the second data stream to the buffer,
wherein changing the second encoding parameter to decrease the data rate for encoding includes:
periodically checking whether a stored data amount of stored data in the buffer is smaller than a decreasing-stop value; and
repeatedly changing the second encoding parameter to decrease the data rate for encoding until the stored data amount of the stored data is smaller than the decreasing-stop value.

6. The data processing method according to claim 3, wherein determining the second encoding parameter further includes:
changing the second encoding parameter to increase a data rate for encoding if the one or more factors satisfy a second preset condition.

7. The data processing method according to claim 6, wherein:
the one or more factors include a stored data amount of a third data stream stored in the buffer; and
determining the second encoding parameter includes:
changing the second encoding parameter to increase a data rate for encoding if the stored data amount of the third data stream is smaller than a lower threshold value.

8. The data processing method according to claim 7, further comprising:
storing the second data stream to the buffer,
wherein changing the second encoding parameter to increase the data rate for encoding includes:
periodically checking whether a stored data amount of stored data in the buffer is larger than an increasing-stop value; and
repeatedly changing the second encoding parameter to increase the data rate for encoding until the stored data amount of the stored data is larger than the increasing-stop value.

9. The data processing method according to claim 1, wherein:
determining the second encoding parameter includes determining a data rate for encoding or a quantization parameter according to the one or more factors, and
encoding the original data to obtain the second data stream according to the second encoding parameter includes encoding the original data to obtain the second data stream according to the data rate for encoding or the quantization parameter.

10. The data processing method according to claim 1, wherein receiving the first data stream from the data source includes receiving the first data stream from one of a camera or an unmanned vehicle.

11. The data processing method according to claim 10, wherein receiving the first data stream from the unmanned vehicle includes receiving the first data stream from a ground-based unmanned vehicle or an unmanned aerial vehicle.

12. The data processing method according to claim 1, wherein encoding the original data to obtain the second data stream includes:
encoding the original data and auxiliary information to obtain the second data stream.

13. The data processing method according to claim 12, wherein the auxiliary information includes at least one of text information or time information.

14. The data processing method according to claim 1, further comprising:
storing the second data stream to a buffer; and
controlling a transmitter to push a data stream stored in the buffer to a receiving device.

15. The data processing method according to claim 14, wherein controlling the transmitter to push the data stream stored in the buffer to the receiving device includes:
performing an authentication with the receiving device;
receiving an address segment from the receiving device;
obtaining a push address according to the address segment; and
controlling the transmitter to push the data stream stored in the buffer to the receiving device according to the push address.

16. The data processing method according to claim 15, wherein obtaining the push address according to the address segment includes:
obtaining the push address according to the address segment and authentication information.

17. The data processing method according to claim 16, wherein:
the authentication information includes a locally stored account and a locally stored key, and
obtaining the push address according to the address segment and the authentication information includes:
combining the address segment, the locally stored account, and the locally stored key to form the push address.

18. The data processing method according to claim 15, wherein controlling the transmitter to push the data stream stored in the buffer to the receiving device according to the push address includes controlling the transmitter to push the data stream stored in the buffer to the receiving device according to the push address within a valid period.

19. The data processing method according to claim 15, wherein controlling the transmitter to push the data stream stored in the buffer to the receiving device according to the push address includes controlling the transmitter to start to push the data stream stored in the buffer to the receiving device according to the push address within a valid period.

20. A data-processing apparatus comprising:
a processor; and
a memory storing instructions that, when executed by the processor, cause the processor to:
receive a first data stream from a data source, the first data stream being obtained by encoding original data according to a first encoding parameter;
decode the first data stream to obtain the original data;
determine, at a data-processing apparatus remote from the data source, a second encoding parameter according to one or more factors that are associated with the data-processing apparatus; and
encode the original data to obtain a second data stream according to the second encoding parameter.
